(19) United States
(12) Patent Application Publication
(10) Pub. No.: US 2008/0267618 A1
(43) Pub. Date: Oct. 30, 2008

(54) Resin substrate and manufacturing method thereof, and camera module having the same and manufacturing method thereof

(75) Inventors: Kyoung Tai Lee, Gyeonggi-do (KR); Yong Gu Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,128

(22) Filed: Apr. 1, 2008

(30) Foreign Application Priority Data
Apr. 24, 2007 (KR) 10-2007-0039666

(51) Int. Cl. G03B 17/02; B32B 3/10; B31B 1/60

(52) U.S. Cl. 396/541; 428/137; 156/60

(57) ABSTRACT

The present invention relates to a resin substrate capable of improving the connectivity of a camera module having the resin substrate and reducing manufacturing time and cost of the camera module by improving the structure of the resin substrate, a manufacturing method thereof, a camera module having the same and a manufacturing method thereof.

Provided are a resin substrate including a substrate body formed a plurality of connection holes on a lateral surface thereof and equipped with lateral pads into the connection holes; and a blocking member installed on a top surface of the substrate body and closing top opening portions of the connection holes, a manufacturing method thereof, a camera module having the same and a manufacturing method thereof.

### CROSS-REFERENCE TO RELATED APPLICATIONS

This application claims the benefit of Korean Patent Application No. 10-2007-0039666 filed with the Korea Intellectual Property Office on Apr. 24, 2007, the disclosure of which is incorporated herein by reference.

### BACKGROUND OF THE INVENTION

1. Field of the Invention

The present invention relates to a camera module, and, more particularly, to a resin substrate capable of improving the connectivity of a camera module and reducing manufacturing time and cost of the camera module, a manufacturing method thereof, a camera module having the same and a manufacturing method thereof.

2. Description of the Related Art

In recent years, with the technique of portable terminals having been developed, the portable terminals such as portable telephones, PDA or the like have been used as multi-convergence such as music, movie, TV, game or the like as well as have a simple functionality as a telephone and a camera module as one of what leads the development of the multi-convergence may be most representative. Such a camera module has been changed by realizing various additional functions such as auto-focusing (AF), optical zoom or the like while being changed from an existing 300 thousand pixels(VGA level) to a high pixel of more than 8 million pixels at present.

Generally, a camera module(CCM: Compact Camera Module) is small and has been applied to various IT equipments such as potable mobile communication equipments or the like including a camera phone or a PDA and a smart phone and recently launch of equipments provided with small camera modules to suit various tastes of consumers has been gradually increased.

Such a camera module has been manufactured using an image sensor such as a CCD or a CMOS or the like as a main component, converges the image of an object through the image sensor to store the converged image on a memory inside equipment as data, and displays the stored data into an image through a display medium such as an LCD or a PC monitor in the equipment.

Hereinafter, a camera module having a resin substrate in accordance with the conventional art will be described in detail with reference to the accompanying drawings as follow.

FIG. 1 is a schematic exploded perspective view showing a camera module having a resin substrate in accordance with a prior art and a connecting socket, FIG. 2 is a schematic cross-sectional view showing a camera module having a resin module in accordance with the prior art, FIG. 3 is a schematic perspective view showing a resin module in accordance with the prior art, FIG. 4 is a schematic perspective view showing a ceramic substrate in accordance with the prior art.

As shown in FIG. 1 and FIG. 2, a camera module having a conventional resin substrate largely consists of a resin substrate 1, an image sensor 2, an infrared blocking filter 3, a housing 4 and a lens barrel 5.

Herein, on a top surface of the resin substrate 1, there is mounted the image sensor 2 as well as mounted various electronic parts such as a condenser and a resistor and semi-conductor devices to drive the image sensor 2.

At this time, as shown in FIG. 3, on the top surface of the resin substrate, there are formed top pads 1c such that the image sensor 2 is electrically connected to the resin substrate 1 through a wire or the like.

Further, on a lateral surface of the resin substrate 1, lateral pads 1b connected to a terminal inside a socket 6 by a side connection method are formed so as to connect the camera module to a portable telephone or the like in an automated method. At this time, connection holes 1a are formed on the lateral surface of the resin substrate 1, and then the lateral pads 1b are formed into the connection holes la such that the camera module is inserted and connected into the socket 6 smoothly.

And the image sensor 2 is composed of a CCD or a CMOS and converts the light impinged through a lens group L mounted inside the lens barrel 5 into an electrical signal.

Further, the infrared blocking filter 3 is installed on a stepped portion formed inside a lower part of the housing 4 and blocks an infrared ray with a long wave included in the light impinged onto the image sensor.

And an edge portion of a bottom surface of the housing 4 is adhered to an edge portion of a top surface of the resin substrate 1 with a thermosetting adhesive in a state where the infrared blocking filter 3 is mounted to the housing 4.

Further, the lens barrel 5 is coupled with a top part of the housing 4 in a screw coupling method in a state where the lens group L is incorporated in the lens barrel.

However, there are the following problems in the camera module having the resin substrate 1 in accordance with a conventional art.

That is, in the conventional camera module, when the housing 4 is boned to the top portion of the resin substrate 1 with an adhesive, there occur problems in that the thermosetting adhesive applied to the edge portion of the top surface of the resin substrate 1 flows to the lateral pads 1b through a top opening portion of the connection holes 1a of the resin substrate 1, thereby inducing a failure of the connection to the terminal of the socket.

At this time, it is so difficult to control the density or the quantity for application of the thermosetting adhesive applied to the resin substrate 1 so as to prevent the thermosetting adhesive from flowing to the lateral pads 1b that when the thermosetting adhesive is applied excessively, it flows to the lateral pads 1b and when it is applied scantily, a failure of the connection of the resin substrate 1 and the housing 4 is induced.

To overcome the above-mentioned problem, a ceramic substrate 1 may be used in a side connection method instead of the resin substrate 1.

That is, as shown in FIG. 4, since the ceramic substrate 11 is formed in a structure that top opening portions of the connection holes 11a formed on the lateral surface thereof are closed, when the ceramic substrate 11 is bonded to the housing with the thermosetting adhesive, the thermosetting adhesive is not flown to the lateral pads 11b formed on the connection holes 11a, thereby preventing the failure from being induced.

However, there are problems in that the ceramic substrate 11 with the above-mentioned structure is possible to be produced by only some companies all over the world to be expensive and the manufacturing period thereof becomes so long that manufacturing period of a camera module having it becomes long and manufacturing cost of the camera module is increased.

Therefore, the development of a resin substrate capable of preventing the thermosetting adhesive from flowing to the lateral pads when being bonded to the housing with replacing the ceramic substrate 11 is required.

### SUMMARY OF THE INVENTION

The present invention has been invented in order to overcome the above-described problems according to the background of the invention. It is, therefore, an object of the present invention to provide a resin substrate capable of preventing a thermosetting adhesive from flowing to a lateral pad of the resin substrate when being bonded to a housing by improving the structure of the resin substrate, thereby improving the connectivity as well as reducing manufacturing time and cost of a camera module having the resin substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic exploded perspective view showing a camera module having a resin substrate and a connecting socket in accordance with a prior art;

FIG. 2 is a schematic cross-sectional view showing a camera module having a resin module in accordance with the prior art;

FIG. 3 is a schematic perspective view showing a resin module in accordance with the prior art;

FIG. 4 is a schematic perspective view showing a ceramic substrate in accordance with the prior art;

FIG. 5 is a schematic exploded perspective view showing a resin substrate in accordance with one embodiment of the present invention;

FIG. 6 is a schematic perspective view showing a resin substrate in accordance with one embodiment of the present invention;

FIG. 7 is a schematic exploded perspective view showing a camera module having a resin substrate and a socket in accordance with one embodiment of the present invention; and

FIG. 8 is a schematic cross-sectional view showing a camera module having a resin substrate in accordance with one embodiment of the present invention.

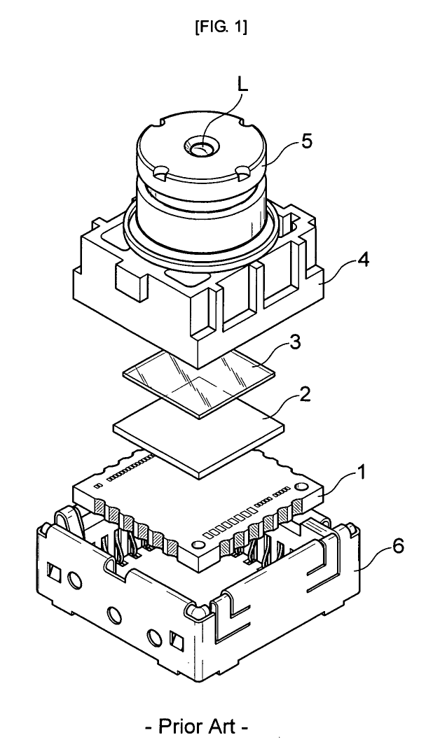

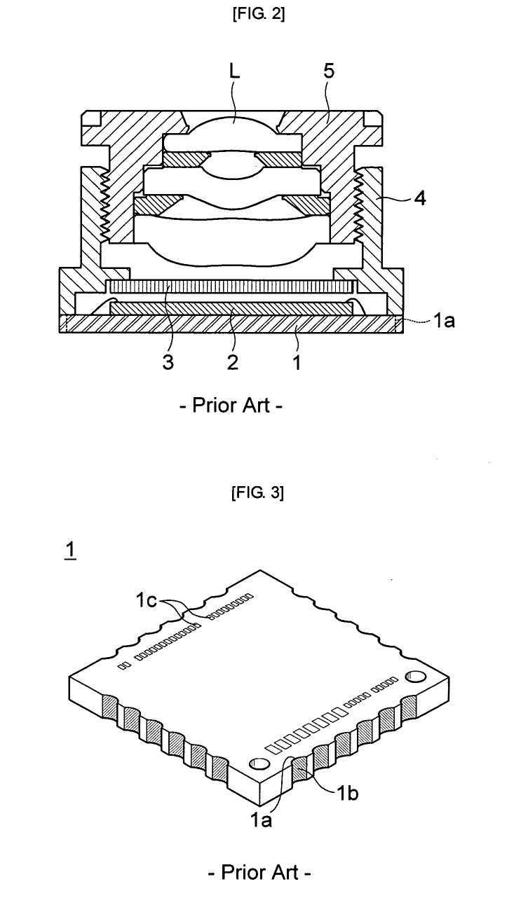

### DETAILED DESCRIPTION OF THE PREFERRED EMBODIMENTS

In accordance with an aspect of the present invention, there is provided a resin substrate including a substrate body formed a plurality of connection holes on a lateral surface thereof and equipped with lateral pads into the connection holes; and a blocking member installed on a top surface of the substrate body to close top opening portions of the connection holes.

Herein, it is preferable that before the connection holes are formed, the blocking member is formed in a shape corresponding to a shape of the substrate body and provided with opening holes to expose top pads formed on the top surface of the substrate body.

And, the blocking member may be composed of a cover lay film including an adhesive material.

Further, the substrate body may be formed by stacking epoxy resin and copper foil in plural.

In accordance with another aspect of the present invention, there is provided a method for manufacturing a resin substrate provided with a substrate body formed a plurality of connection holes on a lateral surface thereof and a blocking member including an adhesive material to be installed on the top surface of the substrate body, including the steps of: receiving the blocking member on the top surface of the substrate body; and adhering and fixing the blocking member onto the top surface of the substrate body by applying heat and pressure to the blocking member.

In accordance with still another aspect of the present invention, there is provided a camera module including a resin substrate provided with a substrate body formed a plurality of connection holes on a lateral surface thereof and equipped with lateral pads into the connection holes and a blocking member installed on the top surface of the substrate body to close top opening portions of the connection holes; an image sensor assembled onto the resin substrate; a housing installed on an upper part of the resin substrate; and a lens barrel installed on a top part of the housing to mount a lens group inside thereof.

In accordance with still another aspect of the present invention, there is provided a method for manufacturing a camera module provided with a resin substrate having a substrate body formed a plurality of connection holes on a lateral surface thereof and a blocking member including an adhesive material to be installed on a top surface of the substrate body, an image sensor assembled onto the resin substrate, a housing installed on an upper part of the resin substrate and a lens barrel installed on a top part of the housing to mount a lens group inside thereof, including the steps of: receiving the blocking member on a top surface of the substrate body; manufacturing the resin substrate by adhering and fixing the blocking member onto the top surface of the substrate body by applying heat and pressure to the blocking member; assembling the image sensor onto the top surface of the resin substrate; installing the housing on the upper part of the resin substrate; and installing the lens barrel on the top part of the housing.

Herein, a bottom edge portion of the housing may be adhered to an edge portion of a top surface of the blocking member with an adhesive.

Hereinafter, a subject regarding to a specific technical configuration and an operation effect thereof corresponding to a resin substrate, a manufacturing method thereof, a camera module having the same and a manufacturing method thereof in accordance with the present invention will be appreciated clearly through the following detailed description with reference to the accompanying drawings illustrating preferable embodiments of the present invention.

### One Embodiment for a Resin Substrate and a Manufacturing Method Thereof

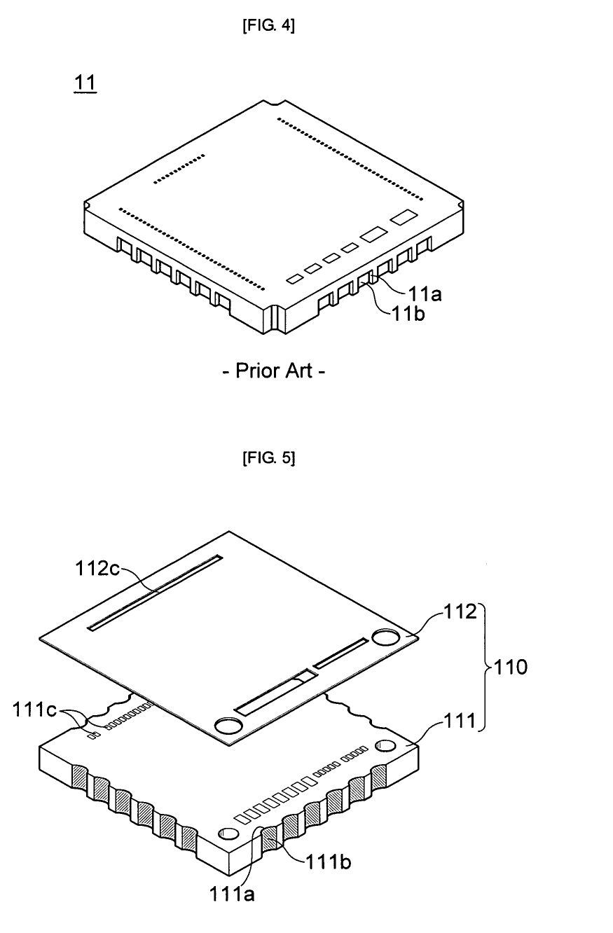

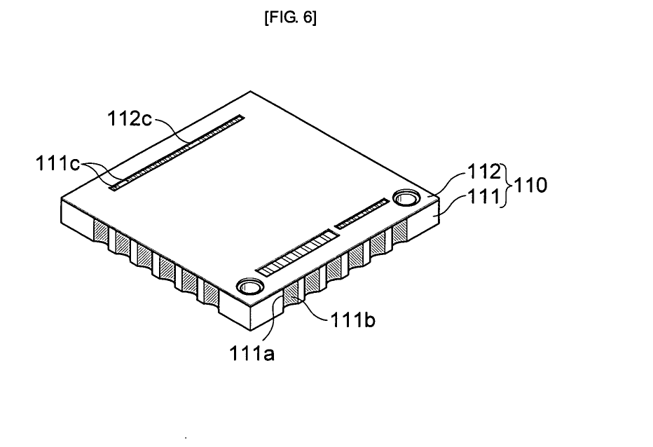

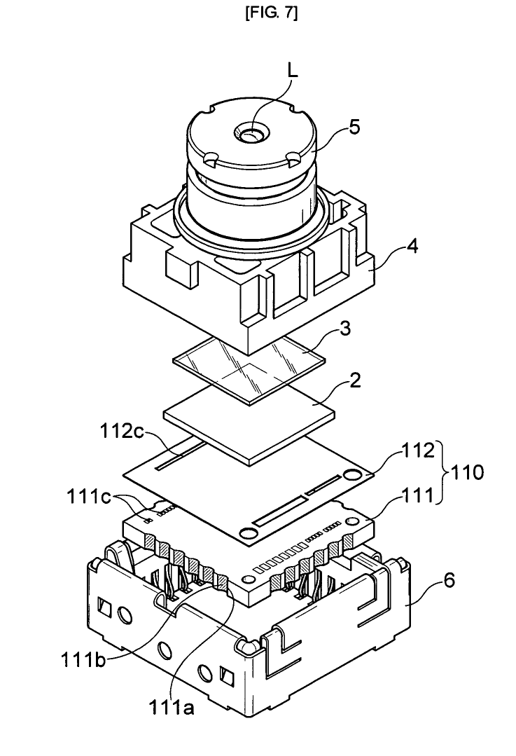

First of all, a resin substrate and a manufacturing method thereof in accordance with one embodiment of the present invention are described with reference to the accompanying FIG. 5 and FIG. 6 as follows.

FIG. 5 is a schematic exploded perspective view showing a resin substrate in accordance with one embodiment of the present invention and FIG. 6 is a schematic perspective view showing a resin substrate in accordance with one embodiment of the present invention.

As shown in FIG. 5, a resin substrate 110 in accordance with the present invention includes a substrate body 111 formed a plurality of connection holes 111a on a lateral surface thereof and equipped with lateral pads 111b into the connection holes 111a and a blocking member 112 installed on a top surface of the substrate body 111 to close top opening portions of the connection holes 111a.

Herein, the substrate body 111 is formed by stacking epoxy resin and copper foil in plural by a conventional method for manufacturing a resin substrate and formed a plurality of top pads 111c on a top surface thereof to be electrically connected to an image sensor.

And, before the connection holes 111a of the substrate body 111 are formed, the blocking member is formed in a square shape corresponding to the shape of the substrate body 111 to be coupled to the top surface of the substrate body 111.

At this time, on the blocking member 112, there is formed an opening hole 112c with various shapes corresponding to the shape and the arrangement structure of the top pads 111c to expose the top pads 111c formed on the top surface of the substrate body 111.

Herein, it is preferable that the blocking member 112 is composed of a cover lay film including an adhesive material.

At this time, the cover lay film has heat resistance and chemical resistance with a low dielectric constant characteristic and high dimensional stability and includes the adhesive material inside and therefore may be adhered to the top surface of the substrate body 111.

A method for manufacturing the resin substrate constructed as described above is as follows.

First of all, the blocking member 112 is received on the top surface of the substrate body 111.

At this time, the blocking member 112 is accurately positioned such that the top pads 111c formed on the top surface of the substrate body 111 are exposed through the opening hole 112c as well as an edge of the blocking member 112 is matched to an edge of the substrate body 111.

Then, the blocking member 112 is adhered and fixed to the top surface of the substrate body 111 by applying heat and pressure to the blocking member 1112.

At this time, when the heat and the pressure are applied, the blocking member 112 is adhered and fixed to the top surface of the substrate body 111 by an adhesive force of the adhesive material since the blocking member 112 includes the adhesive material.

Herein, before the connection holes 111a of the substrate body 111 are formed, the blocking member 112 is formed in a square shape corresponding to the shape of the substrate body 111 and adhered and fixed to the top surface of the substrate body 111, whereby the top opening portions of the connection holes 111a of the substrate body 111 are closed by the blocking member 112.

That is, the blocking member 112 plays a role of a roof to close the top opening portions of the connection holes 111a of the substrate body 111.

Accordingly, when there is liquefied contaminant on the top surface of the blocking member, although the contaminant flows downward, the contaminant is not flown into the lateral pads 111b formed into the connection holes 111a of the substrate body 111.

Meanwhile, although the embodiment of the present invention is explained for a manufacturing method provided with a blocking member 112 in a state where a substrate body 111 is diced in a shape of unit, unlike the embodiment of the present invention, after adheing the blocking member 112 of a size and a shape corresponding to an array at a state of the array before being diced in the shape of unit, the substrate body 111 can be manufactured by dicing the resin substrate in a shape of unit.

### One Embodiment for a Camera Module and a Manufacturing Method Thereof

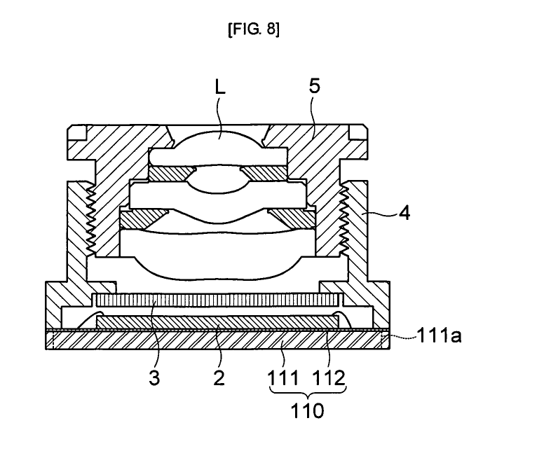

Next, a camera module including a resin substrate in accordance with the present invention and a manufacturing method thereof are described with reference to the accompanying FIG.7 and FIG. 8 as follows.

FIG. 7 is a schematic exploded perspective view showing a camera module including a resin substrate and a socket in accordance with one embodiment of the present invention and FIG. 8 is a schematic cross-sectional view showing a camera module including a resin substrate in accordance with one embodiment of the present invention.

As shown in FIG. 7, a camera module in accordance with one embodiment of the present invention includes the above-described resin substrate 110, an image sensor 2 assembled onto the resin substrate 110, a housing 4 installed on an upper part of the resin substrate 110, an infrared blocking filter 3 mounted inside the housing 4 to block an infrared ray included in the light impinged onto the image sensor 2 and a lens barrel 5 installed on a top part of the housing 4 to mount a lens group L inside thereof.

Herein, the image sensor 2 is composed of a CCD or a CMOS and converts the light impinged through the lens group L mounted inside the lens barrel 5 into an electrical signal.

Further, the infrared blocking filter 3 is installed on a stepped portion formed inside a bottom part of the housing 4 to block an infrared ray with a long wavelength included in the light impinged to the image sensor 2.

And an edge portion of a bottom surface of the housing 4 is adhered to an edge portion of the top surface of the resin substrate 1 with a thermosetting adhesive in a state where the infrared blocking filter 3 is mounted to the housing 4.

Further, the lens barrel 5 is coupled with a top part of the housing 4 in a screw coupling method in a state where the lens group L is incorporated in the lens barrel 5.

The camera module formed as mentioned above is connected to a portable telephone or the like through the socket 6 in an automated method.

That is, the camera module is connected to the socket 6 in an insertion method, wherein at this time, the lateral pads 111b formed on the substrate body 111 of the resin substrate 110 are in contact with a plurality of terminals provided inside the socket 6 to be electrically connected to each other.

A method for manufacturing the camera module constructed as described above is as follows.

First of all, referring to FIG. 8, the image sensor 2 is electrically mounted onto the top surface of the resin substrate 110 formed by the above-mentioned method through a wire.

And, the thermosetting adhesive is applied to the edge portion of the top surface of the resin substrate 110, that is, the edge portion of the top surface of the blocking member 112 and a bottom edge portion of the housing 4 mounted thereon the infrared blocking filter 3 is adhered to the edge portion of the top surface of the blocking member 112 through the thermosetting adhesive.

At this time, since the blocking member 112 plays a role of a roof to close the top opening portion of the connection holes 111a of the substrate body 111, although the thermosetting adhesive falls to a lower part outside the blocking member 112 due to an adhesive force of the housing 4, the falling and flowing thermosetting adhesive is not flown to the lateral pads 111b formed on the connection holes 111a of the substrate body 111.

Accordingly, the connectivity of the lateral pads 111b to the terminals of the socket 6 is improved since the lateral pads 111b are not contaminated by the thermosetting adhesive.

Meanwhile, the resin substrate 110 and the housing 4 are adhered, and then the lens barrel 5 is coupled with the top part of the housing 4 in a screw coupling method, thus finishing manufacturing the camera module.

As mentioned above, in accordance with the present invention, the resin substrate is capable of improving the connectivity to the external terminals through the lateral pads by preventing the lateral pads connected to the external terminals in a side method from being contaminated by the thermosetting adhesive.

And, in accordance with the present invention, it is possible that the resin substrate replaces an expensive ceramic substrate for preventing the thermosetting adhesive from flowing into the lateral pads, thus reducing manufacturing cost and time of the camera module to improve the production efficiency of the camera module.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A resin substrate comprising:
a substrate body formed a plurality of connection holes on a lateral surface thereof and equipped with lateral pads into the connection holes; and
a blocking member installed on a top surface of the substrate body to close top opening portions of the connection holes.

2. The resin substrate according to claim 1, wherein the blocking member is formed in a shape corresponding to a shape of the substrate body before the connection holes are formed.

3. The resin substrate according to claim 1, wherein the blocking member includes an opening hole to expose top pads provided on the top surface of the substrate body.

4. The resin substrate according to claim 1, wherein the blocking member is a cover lay film including an adhesive material.

5. The resin substrate according to claim 1, wherein the substrate body is formed by stacking epoxy resin and copper foil in plural.

6. A method for manufacturing a resin substrate provided with a substrate body formed a plurality of connection holes on a lateral surface thereof and a blocking member including an adhesive material to be installed on the top surface of the substrate body comprising the steps of:
receiving the blocking member on the top surface of the substrate body; and
adhering and fixing the blocking member onto the top surface of the substrate body by applying heat and pressure to the blocking member.

7. A camera module comprising:
a resin substrate provided with a substrate body formed a plurality of connection holes on a lateral surface thereof and equipped with lateral pads into the connection holes and a blocking member installed on a top surface of the substrate body to close top opening portions of the connection holes;
an image sensor assembled onto the resin substrate;
a housing installed on an upper part of the resin substrate; and
a lens barrel installed on a top part of the housing to mount a lens group inside thereof.

8. A method for manufacturing a camera module provided with a resin substrate including a substrate body formed a plurality of connection holes on a lateral surface thereof and a blocking member including an adhesive material to be installed on the top surface of the substrate body, an image sensor assembled onto the resin substrate, a housing installed on an upper part of the resin substrate and a lens barrel installed on a top part of the housing to mount a lens group inside thereof comprising the steps of:
receiving the blocking member on the top surface of the substrate body;
manufacturing the resin substrate by adhering and fixing the blocking member onto the top surface of the substrate body by applying heat and pressure to the blocking member;
assembling the image sensor onto the top surface of the resin substrate;
installing the housing on the upper part of the resin substrate; and
installing the lens barrel on the top part of the housing.

9. The method according to claim 8, wherein a bottom edge portion of the housing is adhered to an edge portion of a top surface of the blocking member with an adhesive.
